(19) United States
(12) Patent Application Publication
(10) Pub. No.: US 2006/0000196 A1
(43) Pub. Date: Jan. 5, 2006

(54) Fluid filter

(76) Inventors: Scott B. Beier, Omaha, NE (US); Gary L. Pospisal, Omaha, NE (US)

Correspondence Address: THOMTE, MAZOUR & NIEBERGALL, L.L.C., 2120 S. 72ND STREET, SUITE 1111, OMAHA, NE, 68124, US

(21) Appl. No.: 10/884,668

(22) Filed: Jul. 2, 2004

(51) Int. Cl. B01D 46/00

(52) U.S. Cl. 55/497; 55/527; 55/528

(57) ABSTRACT

A fluid filter is disclosed which comprises a layer of high loft, non-woven, fibrous, fluid-permeable material having a length and a width, an upper surface, a lower surface, and a thickness measured between the upper and lower surfaces which is non-constant. The non-constant thickness is achieved by providing a series of spaced-apart grooves separated by a series of spaced-apart ridges. The lower surface is substantially planar and the grooves each have a generally U-shaped cross section with the ridges having a generally inverted U-shaped cross section. A modified form of the invention is also disclosed wherein the zones of higher flow resistance have a greater density than the zones of lower flow resistance. In this embodiment, the thickness of the filter is constant. The method of filtering particulate material from a fluid stream is also disclosed.

### BACKGROUND OF THE INVENTION

1. Field of the Invention

This invention relates generally to a fluid filter and more particularly to a fluid filter having different pressure drop/flow rate zones across the width and/or length thereof. More particularly, this invention relates to a filter for the removal of particulate from a fluid comprised of a batting of high loft, non-woven, fibrous, fluid-permeable material having alternating zones of higher and lower fluid flow resistance wherein every two zones of higher flow resistance are separated by a zone of lower flow resistance and every two zones of lower flow resistance are separated by a zone of higher flow resistance.

2. Description of the Related Art

Many materials and combinations of materials, have been used as filtration media or fluid filters to remove solid or liquid particulate from fluid streams. The capabilities of such fluid filters are judged according to three main criteria: (1) the particulate removal efficiency (i.e., the ability of the filter to capture and retain particulate); (2) the pressure drop for a given flow rate of fluid through the filter (which is utilized as a measure of the power required to move the fluid stream through the media); and (3) the holding capacity (i.e., the total amount of particulate which can be retained by the filter before the pressure drop becomes so great that the filter must be cleaned or replaced).

Residential and commercial heating, ventilating and air conditioning systems (HVAC systems) deal with a wide variety of particulate, including dust, lint and pollen. Similar filtration systems are utilized in industrial spray painting booths to collect paint droplets (i.e., overspray) from the exhaust air stream. Dust collection systems are also utilized in industrial settings to capture the by-products of manufacturing processes which are entrained in air streams. Obviously, the removal of such particulate in all of these settings is desirable for reasons of health, comfort and aesthetic appeal.

All filter media rely generally on either the attractive force between the filter media and the particulate, or “physical barrier filtration”, to remove particulate from a fluid stream. The use of attractive forces includes electromechanical forces as well as chemical/adhesive forces. An example of electromechanical forces includes electrostatic filtration, wherein the electrical charge on the particulate, and the electrical charge on a filter media are such that the particulate is attracted to and retained on the filter media. An example of chemical/adhesive forces is present in the filtration of paint droplets from an air stream, wherein the paint droplets will adhere to the surface of the filter media when contact between the two occurs. Physical barrier filtration utilizes filter media with openings sufficiently small to prevent particulate of a predetermined size (larger than the openings) from passing through the filter media.

Prior art “disposable” filters are designed to be built from low cost materials which may be affordably replaced when the filters become “dirty” (i.e. when the increased pressure drop due to retained particulate requires an undesirable increase in energy to move the fluid stream through the filter). Disposable filters are generally comprised of four constructions: (1) constant thickness, thick sheets (½ inch to 2 inch) of stabilized, high loft, non-woven fibrous media; (2) constant thickness, thin sheets (less than 1/16 inch) of stabilized non-woven fibrous media laminated to a metallic mesh material and then mechanically pleated; (3) constant thickness, thin sheets (less than ¼ inch) of stabilized woven or non-woven fibrous media which has been sewn or glued to form a filter element which consists of three-dimensional multiple “bags”; and (4) stacked layers of expanded paper.

The stabilized, non-woven fibrous materials used for the first three above-described types of disposable filtration media are generally produced from natural and/or man-made fibers such as glass, cotton, polyester or polypropylene. The individual fibers may be either of a discrete staple length or continuous filaments. The stabilization methods for these fibrous media are generally mechanical (such as needle punching), chemical (utilizing glues or binders), or thermal (utilizing plastic materials incorporated within a batting which are melted to bind the remainder of the fibers upon cooling of the melted material). The stabilized woven fibrous materials generally consist of layered sheets of large diameter man-made filaments or threads loosely woven to form a fabric sheet.

The fourth construction type identified above typically consists of a plurality of layers of expanded paper. Each layer of this type of filter is created from a continuous sheet of paper which has been slit repeatedly, allowing the paper to be stretched in a fashion similar to an expanded metal screen. In this stretching process, each discrete slit widens, creating multiple openings through the paper. During the stretching of each paper layer, the strips of the paper between slits naturally twist to form a three-dimensional structure. Layers of the expanded paper are then stacked atop one another resulting in a three-dimensional assembly having tortuous paths of openings through its thickness through which an air stream is directed.

Typically, the selection of a particular construction type is dependent upon a variety of factors, including cost requirements and the specific type of particulate to be captured.

Since the present invention was first developed with a view towards use in a paint booth exhaust system, the problems associated with prior art filters in this setting will be more specifically addressed. The first decision to be made in filtration systems for paint booths is the type of filter structure to be utilized. For example, expanded paper filters are typically not effective barrier filters because of the large individual openings through the expanded paper filter. However, expanded paper filters can be effective in paint arrestance applications, because of the adhesive nature of many types of paint droplets. The contact of a paint droplet, entrained in an air stream, with the surface of the paper as an air stream proceeds along the tortuous path through the filter, causes the droplet to adhere to, and be retained in, the filter.

The main drawback with paper filters in paint arrestance applications lies in the fact that paint droplets passing through the filters exist in a very large range of sizes. Depending upon the size of the droplet and the type of paint, the paint droplets can dry and lose their adhesive qualities before contacting the filter media. In such a case, the solid paint particulate will not adhere to the paper, but rather will “bounce” through the filter media as it is pushed by the air stream moving through the filter. In an attempt to overcome this particular problem, many prior art paper filters utilize a thin layer of high loft non-woven batting as a final filtration stage, to capture dried paint droplets. The use of a high loft non-woven batting for the final stage of an expanded paper filter differs from the present invention in that the high loft fibrous medias used as the final layer behind the paper are generally constant thickness, consistent flow rate medias, and the paper is non-fluid permeable creating zones of flow and no-flow. The main advantage of utilizing an expanded paper filter for paint particle filtration from an air stream is in the large size of the openings through the paper, and the tortuous path taken by the air stream through the filter media. The large openings allow for the retention of significant quantities of paint particulate before the opening becomes overly restrictive due to paint accumulation. Even so, the restriction of the opening size increases the pressure drop through the media, thereby increasing the energy required to move air through the filter media and ultimately requiring replacement of the filter. The tortuous path increases the probability that paint droplets will contact the paper so as to adhere to the filter material.

While the expanded paper filter provides advantageous use in the area of paint arrestance, fibrous non-woven filter media are more adaptable to a wide variety of particulate filtration applications. In the production of non-woven battings from man-made fibers, the denier (the relative diameter) of the fibers may be chosen so as to define the size of the effective openings through the batting and thereby the effectiveness of the barrier filtration characteristic of the filter. In general, the larger the denier of fiber utilized, the larger the effective opening sizes through the batting.

In determining an appropriate opening size for filter media, the characteristic of “surface loading” must be considered. Because the density of the particulate within the air stream is greater when the air stream enters the surface of the media, this entrance surface will generally “load” much more quickly than locations deeper within the filter. This loading obviously restricts the opening size and thereby increases the pressure drop of the filter media. Because of the loading of this surface, the filter media will require replacement (due to the increased pressure drop at the entrance surface) well before the full extent of the media has been utilized in capturing particulate from the air stream.

It can therefore be seen that a compromise must be made between larger opening sizes (which provide lower pressure drop, greater holding capacity, and less surface loading) and smaller opening sizes (which provide increased particulate removal efficiency through a greater range of particulate size). While the fiber size may be adjusted as part of the “compromise,” additional methods have been utilized to enhance the holding capacity of filter media without compromising the removal efficiency. Four general methods have been utilized in the prior art: (1) pleating of the media; (2) sewing or gluing the media into multiple “bags” that are constructively attached to each other to form an extended surface filter assembly; (3) multiple stage filters; and (4) mist separators.

In the first method, the filter media is pleated so as to increase the surface area of the filter element while retaining a small opening size. Typically, a thin metal mesh is laminated to the media to form a product which is mechanically pleated into an “accordion” shape. There are several drawbacks to this method. First, there is an increased cost in view of the metal material utilized and the lamination/pleating steps. Second, safety risks increase during the handling of the metal mesh due to the very sharp edges of the mesh. An increase in disposal and recycling problems are created by the combination of metal and otherwise disposable fibrous products. Finally, there is a lack of tensile strength in this type of filter media.

In order to utilize the pleated material described above, it must be adequately supported by an external frame, adding to the increased cost referenced above. Otherwise, any application of tensile forces perpendicular to the pleat lines of the filter media would result in the flattening of the pleats. This lack of tensile strength prohibits the use of such filter media in any application which requires high tensile strength (such as on-roll commercial HVAC filtration in which the media is pulled from a supply roll, across the air duct work, and then wound up on a collection roll).

The second method identified above consists of sewing or gluing the filter media into multiple “bag” assemblies which are open at the entry plane of the filter and which extend downstream. Drawbacks of this method include the higher manufacturing costs of producing the “bags” and the higher initial cost in utilizing additional piping and physical space for this type of filter.

The third method utilized to improve the holding capacity of the media is to produce a multiple stage filter in which continuous, homogenous layers of non-woven fiber battings having different effective openness are laminated together. This creates a filtration media wherein the fluid steam is first presented to a more open layer made from larger denier fibers, for removal of larger size particulate. The fluid stream then advances to layers of successively reduced openness to remove remaining smaller size particulate. The resultant filter is as efficient as that stage which has the smallest openings, but said final stage is not exposed to the full quantity of particulate (some particulate has been removed by the earlier stages) and thereby minimizes the surface loading effect and extends the usable life of the filter.

The main drawbacks to the described multiple stage filter are the added costs of assembling multiple layers of differing media and the entrance plane of the first layer and the interfaces between layers still act as entrance surfaces and are therefore subject to surface loading. In the case of paint arrestance filters where the paint droplets are of an adhesive nature, even a very open, yet still continuous and of consistent thickness and density, fiber batting will capture most droplets at the entrance plane of the first batting causing surface loading of this batting. While the surface loading effect is minimized by the layered arrangement, it is still present.

The final method of enhancing a filtration media is described in U.S. Pat. No. 4,443,233 showing an improved mist separator. In this patent, a plate of metal is formed into a shape having raised and lowered areas. A fluid stream traveling through the plate follows tortuous changes of direction. During these changes of directions, large droplets (having greater momentum) will not change direction with the fluid stream, but rather will continue in a straight line until contact is made with the plate. In the use of such a filter to remove liquid particulate from an air stream, the liquid would condense on the plate, and the surface tension of the liquid would retain it on the plate.

Use of the mist separator filtration media for solid particulate filtration presents two major drawbacks. First, there would be a higher cost of materials due to the use of a metal plate, which thereby restricts the use of this media as a disposable filter. Second, the ability of the plate to retain solid particulate is minimal, because of the limitations of electromechanical attractions. After only a slight buildup of solid particulate occurs on the plate, the force of the fluid stream traveling past the plate would become sufficient to dislodge any additional buildup. In fact, the patent indicates that it is still necessary to provide a final stage of standard non-woven batting to capture smaller solid particulate.

In addition, this layer of standard batting would suffer severely from the surface loading effect since the presence of the metal plate would actually reduce the surface area of the batting due to its intimate non-fluid permeable contact with the batting.

### SUMMARY OF THE INVENTION

The fluid filter of the present invention includes a layer of high loft, non-woven, fibrous, fluid-permeable material having a length and a width, an upper surface, a lower surface, and a thickness measured between the upper and lower surfaces which is non-constant in the preferred embodiment. The non-constant thickness is achieved by providing a series of spaced-apart grooves extending into the upper surface. Further, the non-constant thickness is achieved by providing a series of alternating grooves, and subsequently formed ridges separating the grooves, formed in the upper surface with the lower surface being substantially planar. In the preferred embodiment of this invention, each of the grooves has a generally U-shaped cross section with the ridges each having a generally inverted U-shaped cross section.

In another embodiment of the invention, the alternating zones of higher and lower flow resistance are achieved by providing alternating zones of higher and lower densities in the filter. In this embodiment, the thickness of the filter is generally constant.

The method of filtering particulate material from a fluid stream is also described which comprises the steps of:

(1) Providing a layer of high loft, non-woven, fibrous, fluid-permeable material, having an upstream surface, a downstream surface, and a thickness measured between the upstream and downstream surfaces which is non-constant or constant, depending upon the embodiment, with the layer having a plurality of elongated, alternating zones of higher and lower flow resistance;

(2) Positioning the layer in the fluid stream so that the fluid stream initially passes through the zones of lower resistance, thence through the layer of material and thence outwardly through the downstream surface of the layer; and

(3) As particulate collects more rapidly in zones of lower flow resistance due to the greater flow of particulate-laden fluid through these zones, the flow resistance increases to these zones causing more fluid to then flow through the previously higher resistance flow areas that have not accumulated as much particulate.

It is therefore a general object of the present invention to provide an improved fluid filter.

Still another object of the invention is to provide a fluid filter and/or filtration media which has a thickness measured between upper and lower surfaces which is non-constant.

Still another object of the invention is to provide a fluid filter which creates zones with differing flow rates.

Still another object of the invention is to provide a fluid filter of the type described above wherein the zones having a higher particulate exposure due to the higher flow of particulate-laden fluid will capture and retain more particulate more quickly than the zones having less exposure due to the lower flow of the particulate-laden fluid.

Yet another object of the invention is to provide a fluid filter that has areas within the filter that stay cleaner longer.

Still another object of the invention is to provide a fluid filter comprised of a batting of high loft, non-woven, fibrous, fluid-permeable material having alternating zones of higher and lower fluid flow resistance wherein every two zones of higher flow resistance are separated by a zone of lower resistance and every two zones of lower flow resistance are separated by a zone of higher flow resistance.

These and other objects will be apparent to those skilled in the art.

### BRIEF DESCRIPTION OF THE DRAWINGS

FIG. 1 is perspective view of the filtration media of this invention;

FIG. 2 is a sectional view of the filtration media of FIG. 1 illustrating the initial flow patterns through the media; and

FIG. 3 is a view similar to FIG. 2, but which illustrates the change in the fluid stream path as the grooves become filled with particulate matter.

### DETAILED DESCRIPTION OF THE INVENTION

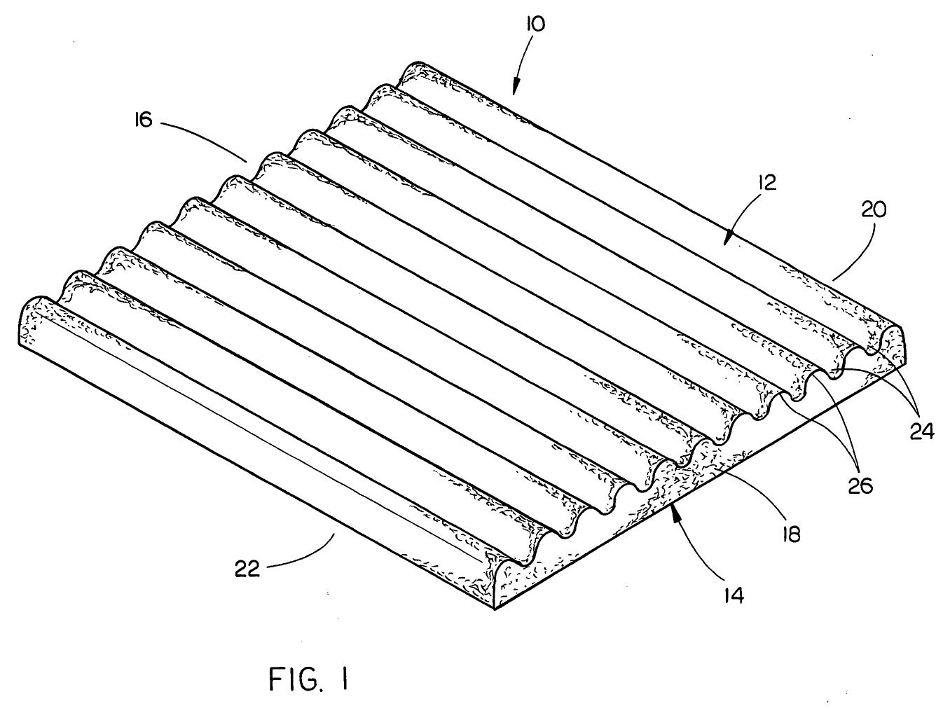

Referring now to the drawings, in which similar or corresponding parts are identified with the same reference numeral, and more particularly to FIG. 1, the fluid filter or filtration media of the present invention is generally designated by the reference numeral 10 which is comprised of a layer of fluid-permeable material having an upper surface 12, lower surface 14, opposite side edges 16 and 18, and opposite ends 20 and 22. As seen in FIGS. 1-3, the filtration media 10 of this invention has a thickness measured between the upper and lower surfaces 12 and 14 which is non-constant. The non-constant thickness is achieved by providing a series of spaced-apart grooves 24 extending into the upper surface 12. The spaced-apart grooves 24 each have a generally U-shaped cross section. The series of alternating grooves 24 are separated by a plurality of alternating ridges 26 which each have a generally inverted U-shaped cross section.

The variable thickness filtration media of this invention differs from the prior art in that the distance between the upper and lower surfaces in the prior art remains relatively constant. The filtration media 10 described herein does not remain constant, but instead varies from a maximum thickness to a minimum thickness which is greater than zero. The transition area between minimum and maximum thicknesses can be a step change or a gradual slope change, such as seen in drawings.

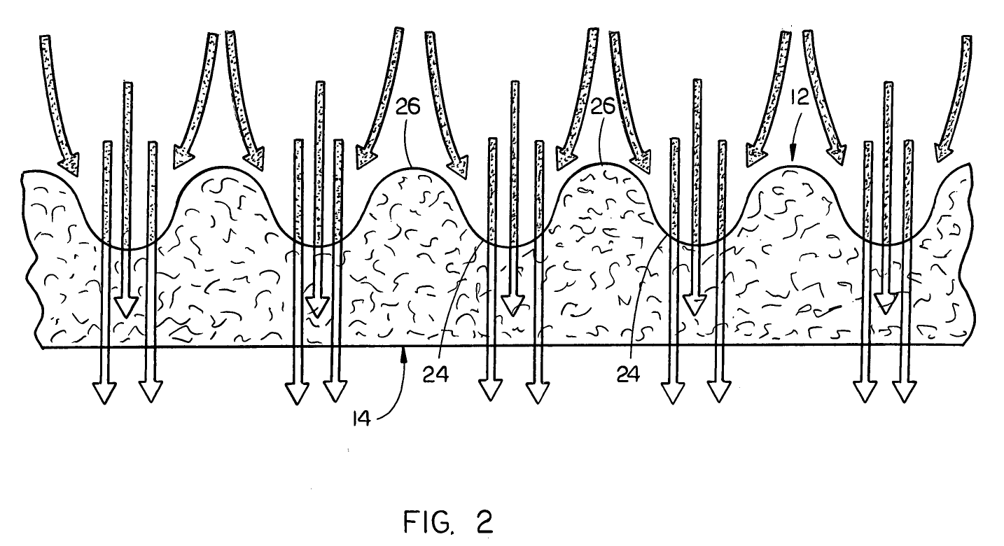

For a given density of a fluid permeable material, it is known that the pressure drop through the media is proportional to the thickness of the material. By creating areas of differing thicknesses, as in the present invention, the media creates equivalent areas of differing pressure drops. Differing pressure drop means differing flow rates through these areas, as seen in FIG. 2 which depicts the initial fluid flow through a clean filter. By varying the pressure drop (from high pressure drop to low pressure drop, to high, to low repeatedly) across the media, flow rates through the media are caused to be variable across the media as well. Since the objective of a media filter is to capture and retain any particulate that is entrained in the process fluid, the type of media disclosed herein will create zones with differing flow rates and, therefore, differing particulate exposure.

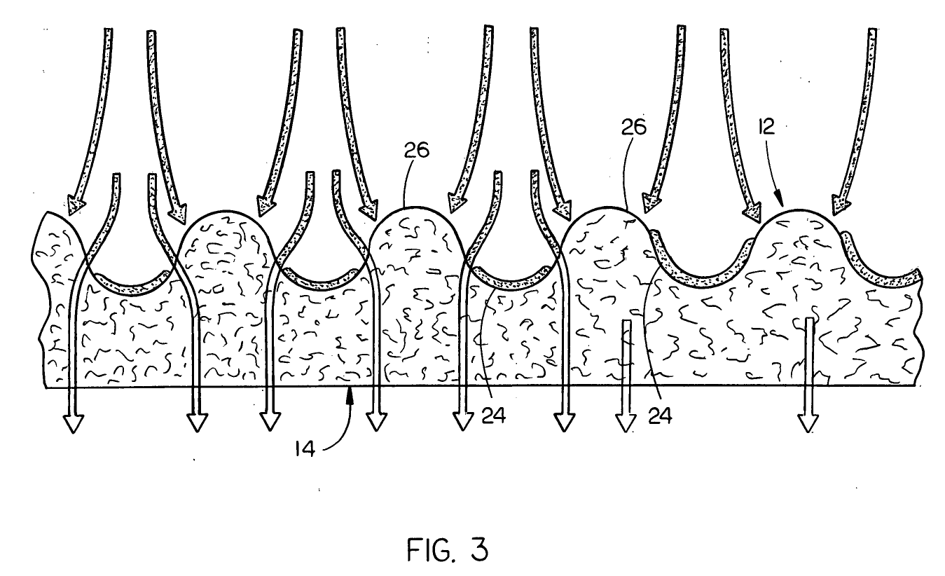

Inasmuch as the U-shaped grooves 24 create a zone having a higher particulate exposure, the U-shaped grooves 24 will capture and retain more particulate faster than zones having less exposure. The pressure drop through these zones will increase more rapidly because of the greater amount of retained particulate. As the pressure drop through the U-shaped grooves 24 increases as they become filled with particulate (FIG. 3), the flow through these zones will decrease and shift to the other areas of the filter that originally had a higher pressure drop (i.e., the areas of the filter with greater thickness) (FIG. 3). This shift of flow now exposes relatively unused (clean) filter media to the incoming particulate. In other words, the flow of fluid containing particulate therein will initially pass into the U-shaped grooves, thence through the media, and thence outwardly through the planar surface 14, since that is the path of least resistance due to the decreased thickness between the inner ends of the grooves 24 and the planar surface 14. As the inner ends of the grooves 24 become clogged with particulate, as illustrated in FIG. 3, the flow path changes so that the clean or unused areas of the filtration media will be exposed to more flow and will remove more particulate from the fluid. The product of this invention results in a filter media having areas within the filter that stay cleaner longer which is an improvement over prior art filter medias. The product of this invention, by having the ridges and grooves formed therein, furthermore presents a greater surface area of media to the fluid flow thereby lessening the surface loading effect.

While the preferred embodiment of the invention is to have the upstream side of the media provided with the ridges and grooves and the downstream side of the media having a planar surface, it is possible that the media could be reversed, that is, the planar surface on the upstream side and the ridges and grooves at the downstream side of the media. Further, it is also possible that the planar surface, whether it is on the upstream or downstream side of the media, could also have an irregular surface so long as the desired areas of higher and lower flow resistance are created.

The alternating zones of higher and lower flow resistance may also be created by providing a layer of fluid-permeable fibrous material having a thickness which is substantially constant with the zones of higher flow resistance having a greater density than the zones of lower flow resistance.

Preferably, both embodiments are comprised of a cotton fiber material or a glass fiber material, or a polyester fiber material or a polypropylene fiber material or a combination of these materials. Preferably, the alternating zones extend substantially across the entire width or extend substantially across the entire length of the fluid filter although the alternating zones may extend an angle with respect to the length or width of the fluid filter.

Thus it can be seen that the invention accomplishes at least all of its stated objectives.

We claim:

1. A fluid filter for the removal of particulate from a fluid stream, comprising:
a single layer of fluid-permeable fibrous material having length and width, an upper surface, a lower surface, and a thickness measured between said upper and lower surfaces which is non-constant;
the non-constant thickness being achieved by providing a series of alternating grooves and ridges in said upper surface.

2. The fluid filter of claim 1 wherein said grooves each have a generally U-shaped cross-section and said ridges each have a generally inverted U-shaped cross-section.

3. The fluid filter of claim 1 wherein fibrous material comprises a non-woven fibrous material.

4. The fluid filter of claim 2 wherein said fibrous material comprises a cotton fiber material.

5. The fluid filter of claim 2 wherein said fibrous material comprises a glass fiber material.

6. The fluid filter of claim 2 wherein said fibrous material comprises a polyester fiber material.

7. The fluid filter of claim 2 wherein said fibrous material comprises a polypropylene material.

8. The fluid filter of claim 2 wherein said fibrous material comprises a combination of cotton fiber material and/or glass fiber material and/or polyester fiber material and/or polypropylene fiber material.

9. The fluid filter of claim 2 wherein said grooves and ridges extend substantially across the entire length of the fluid filter.

10. The fluid filter of claim 2 wherein said grooves and ridges extend substantially across the entire width of the fluid filter.

11. The fluid filter of claim 2 wherein said grooves and ridges extend at an angle with respect to the length of the fluid filter.

12. A fluid filter, comprising:
a single layer of fluid-permeable fibrous material having length and width, an upper surface, a lower surface, and a thickness measured between said upper and lower surfaces, said material having alternating zones of higher and lower fluid flow resistance wherein zones of higher flow resistance are separated by a zone of lower flow resistance and wherein zones of lower flow resistance are separated by a zone of higher flow resistance;
said zones of higher flow resistance having a greater density than said zones of lower flow resistance.

13. The fluid filter of claim 12 wherein said material has a thickness which is substantially constant.

14. The fluid filter of claim 12 wherein fibrous material comprises a non-woven fibrous material.

15. The fluid filter of claim 12 wherein said fibrous material comprises a cotton fiber material.

16. The fluid filter of claim 12 wherein said fibrous material comprises a glass fiber material.

17. The fluid filter of claim 12 wherein said fibrous material comprises a polyester fiber material.

18. The fluid filter of claim 12 wherein said fibrous material comprises a polypropylene fiber material.

19. The fluid filter of claim 12 wherein said fibrous material comprises a combination of cotton fiber material and/or glass fiber material and/or polyester fiber material and/or polypropylene fiber material.

20. The fluid filter of claim 12 wherein said alternating zones extend substantially across the entire length of the fluid filter.

21. The fluid filter of claim 12 wherein said alternating zones extend substantially across the entire width of the fluid filter.

22. The fluid filter of claim 12 wherein said alternating zones extend at an angle with respect to the length of the fluid filter.
